(19) United States
(12) Patent Application Publication
(10) Pub. No.: US 2009/0162703 A1
(43) Pub. Date: Jun. 25, 2009

(54) Glass Substrate for Information Recording Medium, and Method of Manufacturing Glass Substrate for Magnetic Recording Medium and Information Recording Medium

(75) Inventor: Hideki Kawai, Hyogo (JP)

Correspondence Address: BRINKS HOFER GILSON & LIONE, P.O. BOX 10395, CHICAGO, IL, 60610, US

(73) Assignee: KONICA MINOLTA, Hachioji-shi (JP)

(21) Appl. No.: 12/086,445

(22) PCT Filed: Oct. 4, 2007
(86) PCT No.: PCT/JP2007/069454

§ 371 Date: Jun. 11, 2008

(30) Foreign Application Priority Data
Oct. 16, 2006 (JP) 2006-280892

(51) Int. Cl. G11B 5/73; B32B 3/00; B32B 3/02; B05D 5/00; G11B 5/84; G11B 5/65; G11B 5/66

(52) U.S. Cl. 428/832; 428/172; 428/66.6; 428/846.2; 427/256; 428/836; 428/835.7; 428/834

(57) ABSTRACT

Not only chemical durability of a glass substrate for an information recording medium is improved, but also no deformation of the substrate and no alteration of substrate characteristics are to be made. A chemical treatment layer formed on the glass substrate surface is made thicker toward a large surface roughness portion of the glass substrate, prior to being subjected to a chemical treatment, from a small surface roughness portion of the glass substrate. Layer thickness D of the resulting chemical treatment layer preferably satisfies the following inequality (1) in view of acquisition of chemical durability.

100 Ra≦D≦3000 Ra (1)

wherein Ra is surface roughness of the glass substrate prior to being subjected to the chemical treatment.

### TECHNICAL FIELD

The present invention relates to a glass substrate for an information recording medium (hereinafter, also referred to simply as “glass substrate”), and a method of manufacturing a glass substrate for a magnetic recording medium and an information recording medium; and specifically to a glass substrate for an information recording medium where a chemical treatment layer partly having different layer thickness is formed on the surface, and a method of manufacturing the glass substrate for a magnetic recording medium and an information recording medium.

### BACKGROUND

Conventionally, magnetic disk substrates are made of aluminum alloys for stationary type desktop computers and servers, and also made of glass substrates for portable type notebook computers and mobile computers, but surface-smoothness of the substrate after polishing tends to be insufficient since not only aluminum alloys are deformable, but also their hardness is insufficient. Further, there was another problem such that a magnetic film was easy to be peeled off the substrate when a head was mechanically brought into contact with the magnetic disk. Thus, glass substrates exhibiting reduced deformation, excellent surface-smoothness and high mechanical strength are expected to be utilized from now on for stationary type apparatuses as well as portable type apparatuses, and also for other home information apparatuses.

However, there was also a problem such that ions are eluted from a glass substrate by using the glass substrate for a long duration. Therefore, various chemical treatment layers each have been utilized so far to be provided on the glass substrate surface to improve chemical durability of the glass substrate. For example, an alkali metal ion on the glass substrate surface is substituted by another alkali ion having an ion diameter larger than that of the alkali metal ion to generate compressed strain, whereby a chemical strengthening treatment is conducted to improve the mechanical strength (Patent Documents 1-3).

Patent Document 1: Japanese Patent O.P.I. Publication No. 7-134823

Patent Document 2: Japanese Patent O.P.I. Publication No. 8-180402

Patent Document 3: Japanese Patent O.P.I. Publication No. 8-124153

### DISCLOSURE OF THE INVENTION

### Problems to be Solved by the Invention

However, since a chemical treatment layer was provided on the entire surface of a glass substrate in the case of the conventional chemical treatment, the surface was not subjected to a chemical treatment only for necessary portions. In this case, a chemical treatment layer having a thickness more than necessary was formed on the main surface on which a recording layer is formed, whereby deformation of the substrate and alteration of substrate characteristics were often produced. In addition, there has been nothing so far to specify a chemical treatment layer in relation to surface-roughness of the glass substrate.

The present invention has been made on the basis of such the situation, and it is an object of the present invention to provide a glass substrate for an information recording medium exhibiting chemical durability, together with no deformation of the substrate and no alteration of substrate characteristics; and to provide a method of manufacturing the glass substrate for the information recording medium.

It is another object of the present invention to provide a magnetic recording medium by which a distance between a magnetic head and the magnetic recording medium surface can be minimized, whereby the recording capacity can be increased.

### Means to Solve the Problems

After considerable effort during intensive studies, the inventors have found out that there is the relationship between surface-roughness of a glass substrate and chemical durability, that is, the chemical durability becomes lower toward a larger surface roughness portion of the glass substrate from a small surface roughness portion of the glass substrate. That is to say, it is a feature that disclosed is a glass substrate for an information recording medium in the present invention, which is subjected to a chemical treatment to form a chemical treatment layer partly having different layer thickness on a surface of the glass substrate, wherein the chemical treatment layer is thicker toward a large surface roughness portion of the glass substrate, prior to being subjected to the chemical treatment, from a small surface roughness portion of the glass substrate.

Layer thickness D of a formed chemical treatment layer preferably satisfies the following inequality (1) in view of acquisition of higher chemical durability.

100 Ra≦D≦3000 Ra (1)

(Ra: surface roughness of the glass substrate prior to being subjected to the chemical treatment)

In the case of a glass substrate for an information recording medium in the form of a disk, and having a through-hole in a central area of the disk, the chemical treatment layer on an inner circumferential glass substrate surface and an outer circumferential glass substrate surface preferably has a thicker layer thickness than that on a main glass substrate surface, and the chemical treatment layer on the outer circumferential glass substrate surface preferably has a thicker layer thickness than that on the inner circumferential glass substrate surface.

In the present invention, further provided is a magnetic recording medium wherein a magnetic recording layer is formed on the foregoing glass substrate.

In addition, “surface roughness” in the present application means arithmetic average roughness specified in JIS B 0601, and surface roughness Ra of a glass substrate prior to being subjected to a chemical treatment is one measured employing AFM (atomic force microscope, manufactured by Digital Instruments, Inc.).

### EFFECT OF THE INVENTION

In the case of a glass substrate of the present invention, since layer thickness of a chemical treatment layer is thicker toward a large surface roughness portion of a glass substrate (that is, a low chemical durability portion), prior to being subjected to a chemical treatment, from a small surface roughness portion of the glass substrate, ion elution from the glass substrate is prevented, whereby trouble in cases where the glass substrate is employed for an information recording medium is resolved.

Higher chemical durability can be obtained when layer thickness D of the chemical treatment layer satisfies foregoing inequality (1).

In the case of a glass substrate for an information recording medium, being in the form of a disk and having a through-hole in a central area of the disk, chemical durability can further be improved, and recording capacity can also be increased, when the chemical treatment layer on an inner circumferential glass substrate surface and an outer circumferential glass substrate surface has a thicker layer thickness than that on a main glass substrate surface.

Further, since a magnetic recording medium of the present invention possesses the foregoing glass substrate and provided thereon, a magnetic recording layer, a distance between a magnetic head and the magnetic recording medium surface can be minimized, whereby the recording capacity can be increased.

### BRIEF DESCRIPTION OF THE DRAWINGS

FIG. 1 is an oblique perspective view showing an example of a method of forming a chemical treatment layer partly having different layer thickness on a glass substrate.

FIG. 2 is a schematic illustration diagram showing an example of a method of forming a chemical treatment layer partly having different layer thickness on a glass substrate.

FIG. 3 is a schematic cross-sectional view of a glass substrate in the present invention.

FIG. 4 is an oblique perspective view showing an example of a magnetic recording medium in the present invention.

### Explanation of Numerals

1 Glass substrate
2 Magnetic film
11 Chemical treatment layer
D Chemical treatment layer thickness
D₁ Chemical treatment layer thickness on the main glass substrate surface
D₂ Chemical treatment layer thickness on the outer circumferential glass substrate surface
D₃ Chemical treatment layer thickness on the inner circumferential glass substrate surface
Ra Surface roughness of the glass substrate prior to being subjected to a chemical treatment
M Magnetic disk

### DESCRIPTION OF THE PREFERRED EMBODIMENTS

It is one of the major features that layer thickness of a chemical treatment layer is thicker toward a large surface roughness portion of a glass substrate from a small surface roughness portion of the glass substrate. In a preparation process of a glass substrate such as a coring process, a lapping process, a polishing process or the like, fine cracks, defects of the glass structure and so forth are generated in the glass substrate, whereby presumably, ionic movement is particularly easy to be produced from these damaged portions. In cases where there are such the damaged portions on the glass substrate surface, surface roughness at the portions becomes generally large. Thus, in the present invention, layer thickness of the chemical treatment layer is made thicker toward a large surface roughness portion from a small surface roughness portion to prevent ion elution and so forth from the damaged portions.

The chemical treatment layer formed on a glass substrate is a layer prepared via a chemical treatment, and examples of the chemical treatment include a chemical strengthening treatment, an ion elution treatment, an ion implantation treatment and so forth. Herein, an alkali metal ion on the glass substrate surface is substituted by another alkali ion having an ion diameter larger than that of the alkali metal ion to generate compressed strain, whereby the mechanical strength is improved via the chemical strengthening treatment. The ion elution treatment is also a treatment of removing an ion component affecting durability of the glass substrate surface employing an aqueous solution of a nitric acid, a hydrochloric acid, a sulfuric acid, an oxalic acid, a citric acid or such. As the treatment conditions, an aqueous solution concentration of roughly 0.01-10% by weight, a treating time of 0.5-100 minutes, and a treatment temperature of room temperature −100° C. are preferable. Further, the ion implantation treatment is a treatment of physically implanting specific chemical species (ions) onto the glass substrate surface. The extent of ion implantation is at a level where no alteration of the glass substrate surface is generated.

Layer thickness D of the chemical treatment layer is determined based on surface roughness Ra of the glass substrate prior to being subjected to a chemical treatment. Generally, layer thickness D of the chemical treatment layer preferably satisfies the following inequality (1).

100 Ra≦D≦3000 Ra (1)

wherein Ra is surface roughness of the glass substrate prior to being subjected to a chemical treatment.

In the case of layer thickness D of the chemical treatment layer thinner than 100 Ra, chemical durability of the glass substrate is not possibly improved, since ion elution from the glass substrate is insufficiently prevented. On the other hand, in the case of layer thickness D of the chemical treatment layer exceeding 3000 Ra, deformation of the glass substrate and alteration of the substrate characteristics tend to be produced. Layer thickness D of the chemical treatment layer more preferably satisfies the following inequality (2).

200 Ra≦D≦2000 Ra (2)

In order to adjust the layer thickness of the chemical treatment layer, chemical treatment conditions of the treating time, the treatment temperature and so forth are changed, or the concentration and kinds of a treating solution are changed. Specifically, in the case of the chemical strengthening treatment, layer thickness D of the chemical treatment layer is adjusted with heating temperature and contact time of a chemical strengthening solution. The higher the heating temperature, the thicker the resulting chemical treatment layer is; and the longer the contact time, the thicker the resulting chemical treatment layer is. In the case of the ion elution treatment, layer thickness D of the chemical treatment layer is adjusted with concentration and treating time of an aqueous solution. The higher the aqueous solution concentration, the thicker the resulting chemical treatment layer is; the longer the treating time, the thicker the resulting chemical treatment layer is; and the higher the treatment temperature, the thicker the resulting chemical treatment layer is. In the case of the ion implantation treatment the layer thickness of the chemical treatment layer is adjusted with kinds of ions implanted onto the glass substrate, implantation speed and so forth.

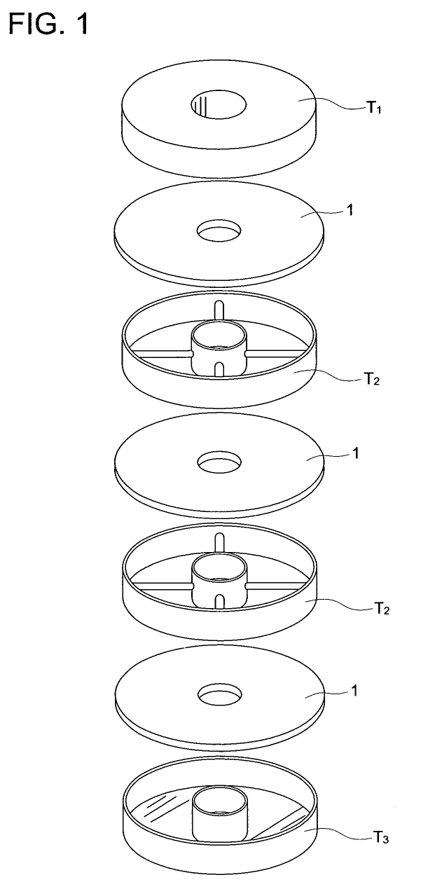

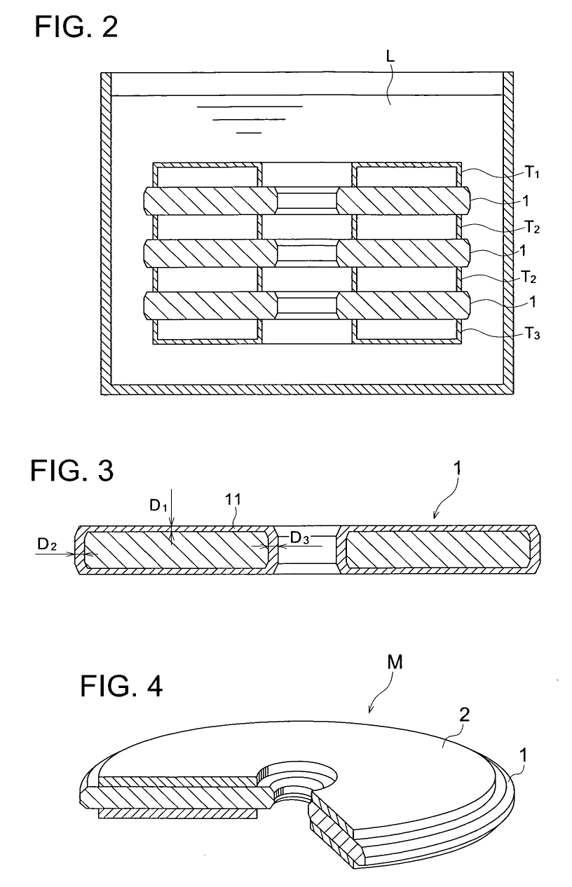

In order to make the chemical treatment layer to partly have different layer thickness, based on surface roughness Ra of the glass substrate prior to being subjected to a chemical treatment, it is convenient to conduct the chemical treatment by dividing into processes for each of the areas subjected to the chemical treatment. For example, a method of partly coating a chemical treatment agent is provided. Utilized are the first step of conducting a chemical treatment at a large surface roughness portion of the glass substrate prior to being subjected to the chemical treatment, and the second step of conducting the chemical treatment at a small surface roughness portion of the glass substrate, and the chemical treatment is carried out in such a way that the chemical treatment layer prepared in the first step has a thicker layer thickness than that of the chemical treatment layer prepared in the second step. In FIG. 1 and FIG. 2, shown are other examples in cases where the chemical treatment is divided into processes for each of the areas subjected to the chemical treatment, and is conducted. In these figures, intermediate jig T₂ is sandwiched between glass substrates 1 being in the form of a disk and having a through-hole in a central area of the disk. And, upper lid jig T₁ is placed on the uppermost glass substrate, and the lowermost glass substrate is placed on lower lid jig T₃. By doing this, each of the upper main surface and the lower main surface of glass substrate 1 is covered with jig T₁, jig T₂ and jig T₃, and only the inner circumferential surface and outer circumferential surface of the glass substrate are exposed. And, as the first step in which the chemical treatment is conducted at the inner and outer circumferential portions having large surface roughness of the glass substrate prior to being subjected to the chemical treatment, layered glass substrates 1 fixed with jig T₁, jig T₂ and jig T₃ as shown in FIG. 2 are immersed in a container, in which chemical treatment solution L is stored, for a predetermined length of time. By doing this, the chemical treatment layer is formed only on the inner circumferential surface and the outer circumferential surface of glass substrate 1. Next, as the second step in which the chemical treatment is conducted at the small surface roughness portions of the glass substrates, the glass substrates are immersed in a container, in which a chemical treatment solution is stored, for a predetermined length of time, after only the main surfaces of the glass substrates are exposed employing other jigs, though no figure is shown. By doing this, the chemical treatment layers are formed on the main surfaces of the glass substrates. In such the chemical treatment, the thickness of the chemical treatment layer on the main surface of the glass substrate, as well as on the inner and outer circumferential surfaces can be varied by changing the immersing time, kinds of the chemical treatment solution, temperature or such.

In the case of a glass substrate in the form of a disk, and having a through-hole in a central area of the disk as shown in FIG. 3, thickness D₂ of chemical treatment layer 11 on the outer circumferential surface of the glass substrate, and thickness D₃ of chemical treatment layer 11 on the inner circumferential surface of the glass substrate are preferably thicker than thickness D₁ of chemical treatment layer 11 on the main surface of the glass substrate. The main surface of glass substrate 1 is the surface portion on which a recording layer is formed, and alteration of substrate characteristics and deformation of the substrate tend to be easily generated in cases where chemical treatment layer 11 at this portion is thick. Further, thickness D₂ of chemical treatment layer 11 on the outer circumferential surface of the glass substrate is preferably thicker than thickness D₃ of chemical treatment layer 11 on the inner circumferential surface of the glass substrate. The reason in this case is that when conducting inner circumferential surface processing and outer circumferential surface processing before conducting the chemical treatment, surface roughness of the outer circumferential surface easily becomes large, since a processing tool such as a processing grind stone, a processing brush or the like touches the outer circumferential surface at higher peripheral speed of the outer circumference than that of the inner circumference.

The main surface of the glass substrate prior to being subjected to a chemical treatment has a surface roughness Ra_{S} of 0.05-1.00 nm, and the inner circumferential surface of the glass substrate and the outer circumferential surface of the glass substrate each have a surface roughness Ra_{E} of 0.5-50.00 nm. Further, when surface roughness Ra_{E} is at least 5 times surface roughness Ra_{S}, each of the chemical treatment layer thickness on the inner circumferential surface of the glass substrate and the chemical treatment layer thickness on the outer circumferential surface of the glass substrate preferably has at least 5 times the chemical treatment layer thickness on the main surface of the glass substrate.

The glass substrates employed in the present invention are not specifically limited. Examples thereof include soda-lime glass containing silicon dioxide, sodium oxide or potassium as a main component; aluminosilicate glass containing silicon dioxide, aluminum oxide or R₂O (R=K, Na or Li) as a main component: boron silicate glass; lithium oxide-silicon dioxide based glass: lithium oxide-aluminum oxide-silicon dioxide based glass; and R′O-aluminum oxide-silicon dioxide based glass (R′=Mg, Ca, Sr or Ba), and zirconium oxide, titanium oxide or such may be added into a glass material thereof.

The size of glass substrates is not also limited.

The method of the present invention can be applied for 2.5 inch disks, 1.8 inch disks, 1 inch disks, 0.85 inch disks and disks smaller than the 0.85 inch disks, and also be applied for thin-type disks such as 2 mm thick disks, 1 mm thick disks, 0.63 mm thick disks and disks thinner than the 0.63 mm disks. Since the glass substrate of the present invention is strengthened by a chemical treatment method, the present invention is suitably applied for thin glass substrates.

Next, an information recording medium fitted with a glass substrate of the present invention will be described. Durability and high recording density are realized by utilizing the glass substrate of the present invention as the substrate for the information recording medium. The information recording medium will be described below referring to a figure.

FIG. 4 shows an oblique perspective view of a magnetic recording medium. Magnetic disk M is one in which magnetic film 2 is directly formed on each of the upper main surface of circular glass substrate 1 and the lower main surface of the glass substrate. Examples of the forming method of magnetic film 2 include a method of forming the magnetic film by spin-coating a thermosetting resin in which magnetic particles are dispersed on a substrate, a method of forming the magnetic film via sputtering, and a method of forming the magnetic film via electroless plating. The layer obtained via spin-coating has a thickness of roughly 0.3-1.2 μm, the layer obtained via sputtering has a thickness of roughly 0.04-0.08 μm, and the layer obtained via electroless plating has a thickness of roughly 0.05-0.1 μm. The film formation carried out via sputtering and electroless plating is preferable in view of thin film formation and high recording density.

Magnetic materials used for magnetic films are not specifically limited, and commonly known ones are usable, but Co exhibiting high magnetocrystalline anisotropy is taken as a base to acquire high coercive force, and the Co system alloy in which Ni and Cr are added is preferable in order to adjust residual magnetic flux density. Examples of the Co system alloy containing Co as a main component include CoPt, CoCr, CoNi, CoNiCr, CoCrTa, CoPtCr, CoNiPt, CoNiCrPt, CoNiCrTa, CoCrPtTa, CoCrPtB, CoCrPtSiO and so forth. A multilayer structure in which magnetic films are sandwiched and isolated by non-magnetic films (Cr, CrMo, CrV and so forth, for example) to make noise reduction may also be utilized. Examples thereof include CoPtCr/CrMo/CoPtCr, CoCrPtTa/CrMo/CoCrPtTa, and so forth. A granular structure in which magnetic particles made of Fe, Co, FeCo, CoNiPt or such are dispersed in a non-magnetic film formed from a ferrite system, an iron-rare earth system, SiO₂, BN or such, other than the above-described materials may also be utilized. Further, the magnetic film may also be utilized in any of an in-plane type recording method and a perpendicular type recording method.

A lubricant may be thinly coated on the magnetic film surface in order to improve sliding of a magnetic head.

As the lubricant, provided is one in which a liquid lubricant such as perfluoropolyether (PFPE) is diluted with a freon based solvent.

An underlayer and a protective layer may also be provided, if desired. The underlayer provided for a magnetic disk is selected depending on the utilized magnetic film. The underlayer is made of at least one selected from the group consisting of Cr, Mo, Ta, Ti, W, V, B and Al as non-magnetic metals, and Ni. In the case of a magnetic film containing Co as a main component, they are preferably a single piece of Co and a Co alloy in view of improvement of magnetic properties. Further, the underlayer is not always a single layer, and a multilayer structure in which identical layers or non-identical layers are laminated may be allowed to be utilized. Examples of the underlayer having the multilayer structure which may be usable include Cr/Cr, Cr/CrMo, Cr/CrV, NiAl/Cr, NiAl/CrMo, NiAl/CrV and so forth.

Examples of the protective layer to prevent wear and corrosion of magnetic films include a Cr layer, a Cr alloy layer, a carbon layer, a carbon hydride layer a zirconia layer, a silica layer and so forth. These protective layers, together with underlayers, magnetic films and so forth can be continuously formed with an in-line type sputtering apparatus. the protective layer may be a single layer, or a multilayer structure in which identical layers or non-identical layers are laminated may be allowed to be utilized. In addition, a different kind of a protective layer may be formed on the above-described protective layer, or the above-described protective layer may be replaced by a different kind of a protective layer. For example, in place of the above-described protective layer, a silicon dioxide (SiO₂) layer may be formed by coating one, in which colloidal silica particles are dispersed in what tetraalkoxy silane is diluted with an alcohol based solvent, on a Cr layer, and further by baking it.

As one embodiment concerning an information recording medium, the magnetic disk has been described as explained above, but the information recording medium is not limited thereto, and glass substrates of the present invention are also usable for magneto optical disks, optical disks and so forth.

### EXAMPLE

### Examples 1-6, and Comparative Examples 1-3)

As shown in Table 1, each of the chemical treatment layers having predetermined layer thicknesses was formed on a glass substrate in which surface roughness is variously changed at the main surface portion, the inner circumferential surface portion and the outer circumferential surface portion, and chemical durability and substrate shape of the glass substrate were measured for evaluation. These results are shown in Table 1.

TABLE 1

| | | | | Layer thickness | | | |
|---|---|---|---|---|---|---|---|
| | Surface | | | D of chemical | | | |
| | roughness Ra | | | treatment layer | | | |
| | (nm) | | | (nm) | | | |
| | *1 | *2 | *3 | *1 | *2 | *3 | Evaluation |
| Example 1 | 0.5 | 1 | 5 | 300 | 2000 | 2000 | *4 |
| Example 2 | 0.5 | 10 | 10 | 75 | 1500 | 1500 | *4 |
| Example 3 | 0.2 | 5 | 5 | 400 | 1000 | 1000 | *4 |
| Example 4 | 1.0 | 10 | 10 | 250 | 15000 | 15000 | *4 |
| Example 5 | 0.3 | 8 | 8 | 150 | 5000 | 3000 | *4 |
| Example 6 | 0.3 | 8 | 8 | 700 | 20000 | 20000 | *4 |
| Comparative | 0.5 | 10 | 10 | 2500 | 2500 | 2500 | Excellent chemical |
| Example 1 | | | | | | | durability, but disk |
| | | | | | | | undulation observed |
| Comparative | 0.2 | 5 | 5 | 25000 | 25000 | 25000 | Excellent chemical |
| example 2 | | | | | | | durability, but large |
| | | | | | | | deformation |
| | | | | | | | of disk observed |
| Comparative | 1.0 | 10 | 10 | 500 | 500 | 500 | Precipitates generated on the |
| Example 3 | | | | | | | inner and outer surfaces when |
| | | | | | | | being left standing in the |
| | | | | | | | atmosphere for 3 weeks after |
| | | | | | | | washing and drying processes |

*1: Main glass substrate surface
*2: Outer circumferential glass substrate surface
*3: Inner circumferential glass substrate surface
*4: Excellent chemical durability, and excellent substrate shape quality

As is clear from Table 1, it is to be understood that in the case of glass substrates in Examples 1-6, excellent chemical durability together with excellent substrate shape quality is obtained, since the chemical treatment layer is made thicker toward a large surface roughness portion of the glass substrate, prior to being subjected to a chemical treatment, from a small surface roughness portion of the glass substrate.

On the other hand, as to glass substrates prior to being subjected to the chemical treatment, in the case of the glass substrates of Comparative example 1 and Comparative example 2 having thicker chemical treatment layer thickness at the main glass substrate surface portion having small surface roughness, the glass substrate of Comparative example 1 generated large undulation, and the glass substrate of Comparative example 2 exhibited large deformation. In contrast, in the case of the glass substrate of Comparative examples 3 having thinner chemical treatment layer thickness both at the inner glass substrate surface portion and at the outer glass substrate surface portion both having large surface roughness, it was observed that precipitates were generated on the inner and outer glass substrate surfaces when being left standing in the atmosphere for 3 weeks after washing and drying processes.

1. A glass substrate having been subjected to a chemical treatment to form a chemical treatment layer partly having different layer thickness on a surface of the glass substrate,
wherein the chemical treatment layer is thicker toward a large surface roughness portion of the glass substrate prior to being subjected to the chemical treatment, from a small surface roughness portion of the glass substrate.

2. The glass substrate of claim 1,
wherein layer thickness D of the chemical treatment layer satisfies the following inequality (1):
100 Ra≦D≦3000 Ra (1)
wherein Ra is surface roughness of the glass substrate prior to being subjected to the chemical treatment.

3. The glass substrate of claim 1,
wherein layer thickness D of the chemical treatment layer satisfies the following inequality (2):
200 Ra≦D≦2000 Ra (2)

4. The glass substrate of claim 1,
wherein the chemical treatment is a chemical strengthening treatment.

5. The glass substrate of claim 1,
wherein the chemical treatment is an ion elution treatment.

6. The glass substrate of claim 1,
wherein the chemical treatment is an ion implantation treatment.

7. The glass substrate of claim 1, being in the form of a disk and having a through-hole in a central area of the disk,
wherein the chemical treatment layer on an inner circumferential glass substrate surface and an outer circumferential glass substrate surface has a thicker layer thickness than that on a main glass substrate surface.

8. The glass substrate of claim 7,
wherein the chemical treatment layer on the outer circumferential glass substrate surface has a thicker layer thickness than that on the inner circumferential glass substrate surface.

9. A magnetic recording medium comprising the glass substrate of claim 1 and provided thereon, a magnetic film.

10. A method of manufacturing a glass substrate for an information recording medium, comprising the steps of:
the first step of conducting a chemical treatment at a large surface roughness portion of the glass substrate prior to being subjected to the chemical treatment to prepare a chemical treatment layer, and
the second step of conducting the chemical treatment at a small surface roughness portion of the glass substrate to prepare the chemical treatment layer,
wherein the chemical treatment layer is thicker toward a large surface roughness portion of the glass substrate prior to being subjected to the chemical treatment, from a small surface roughness portion of the glass substrate.

11. The method of claim 10,
wherein each of the first step and the second step comprises
process of coating a chemical treatment agent on the glass substrate.

12. The method of claim 10,
wherein each of the first step and the second step further comprises
a process of exposing a portion of the glass substrate being subjected to the chemical treatment by covering another portion of the glass substrate being not subjected to the chemical treatment, and
a process of immersing the glass substrate in a container in which a chemical treatment solution is stored.

13. The method of claim 12,
wherein the first step comprises a process of immersing layered glass substrates in the container for a predetermined length of time.

14. The method of claim 12,
wherein the second step comprises a process of immersing glass substrates in the container for a predetermined length of time, after exposing only main surfaces of the glass substrates.

15. The magnetic recording medium of claim 9, comprising the magnetic film employed in a perpendicular type recording method.

16. The magnetic recording medium of claim 9, comprising the magnetic film and a lubricant coated on a surface of the magnetic film surface.

17. The magnetic recording medium of claim 16,
wherein the lubricant is one in which perfluoropolyether is diluted with a Freon based solvent.

18. The magnetic recording medium of claim 9, comprising the magnetic film provided thereon a protective layer.

19. The magnetic recording medium of claim 18,
wherein the protective layer comprises a Cr layer, a Cr alloy layer, a carbon layer, a carbon hydride layer, a zirconia layer, or a silica layer.

20. The magnetic recording medium of claim 9, comprising the magnetic film and an underlayer.
